(19) United States
(12) Patent Application Publication
(10) Pub. No.: US 2014/0304916 A1
(43) Pub. Date: Oct. 16, 2014

(54) FOLDING FIVE-BEND ELECTRIC BED

(71) Applicant: Anmin GUO, Shanghai (CN)

(72) Inventor: Anmin GUO, Shanghai (CN)

(21) Appl. No.: 13/919,379

(22) Filed: Jun. 17, 2013

(30) Foreign Application Priority Data
Apr. 15, 2013 (CN) 201310129544.3

(51) Int. Cl. A61G 7/015; A61G 7/018

(52) U.S. Cl. CPC A61G 7/015; A61G 7/018
USPC 5/616

(57) ABSTRACT

A folding five-bend electric bed includes two bed frames folded over each other, and transverse bars provided on the bed frames. The bed frames are articulated by active rotating shafts therebetween, and bed legs are provided at the bottom of the four corners and the center of the bed frame. A bed body is installed inside the bed frames. A front electric device and a rear electric device are installed at the centers below the two bed frames, respectively. The front end of a front screw pushrod is connected to a front supporting seat at the bottom of a head unit active frame and a front end of a rear screw pushrod is connected to a rear supporting seat at the bottom of a calf unit active frame by front and rear rotating shafts, respectively.

### TECHNICAL FIELD

This invention relates to the technical field of bed products and pertains to a folding five-bend electric bed.

### BACKGROUND ART

At present, most of the existing domestic bed products are designed to be of a planar-linear type, and foldable beds can only be two-fold, which have a single function, provide poor comfort, and can not meet the needs of different groups of people.

### SUMMARY OF THE INVENTION

The purpose of the present invention is to provide a folding five-bend electric bed based on the natural physiological curves of the human body. Steel-frame structures are utilitized to form frames that can be linked to each other, on which a number of articulation points are set and two miniature wireless remote control electric devices are provided. By the remote control buttons, angles of the front and rear ends of the bed body may be adjusted as desired, so that the whole bed surface forms a five-bend state, in which the front end is highed than the rear end, and the bed head and the bed foot can be raised, lowered and bent automatically. Such that when a buman body is in a supine position, the head and neck, back, buttocks, thighs and calves, which are subject to no compression of any part of the bed body, are always in the best natural state, thereby promoting blood circulation and eliminating fatigue, providing good comfort, and satisfying the requirements of people to live, study, convalescence and rest to the maximum extent. At the mean time, it is multi-use and can also be used as a flat bed. The bed body can be folded together for easy transport, storage and use, and can be widely used in hotels, hospitals, homes, etc., compeletely meeting the needs of different groups of people.

To achieve the above objects, the present invention adopts the following technical solutions:

A folding five-bend electric bed, which is characterized in that it comprises two bed frames folded over each other, transverse bars are provided on the bed frames, the two bed frames are articulated by active rotating shafts therebetween, and bed legs are provided at the bottom of the four corners and both sides of the center of the bed frame;

A bed body composed of a head unit active frame, a waist unit active frame, a thigh unit active frame, a calf unit active frame and a buttock fixed bed surface is installed inside the bed frames; The head unit active frame and the waist unit active frame are hinged to each other by an active rotating shaft; The waist unit active frame and the active rotating shaft on the bed frame at the buttock fixed bed surface are hinged to each other; The thigh unit active frame and the calf unit active frame are hinged to each other by an active rotating shaft; The thigh unit active frame and the active rotating shaft on the bed frame at the buttock fixed bed surface are hinged to each other;

A front electric device having a front screw pushrod thereon and a rear electric device having a rear screw pushrod thereon are installed at the centers bellow the two bed frames, respectively, the front end of the front screw pushrod is connected to a front supporting seat at the bottom of the head unit active frame by a front rotating shaft, and the front end of the rear screw pushrod is connected to a rear supporting seat at the bottom of the calf unit active frame by a rear rotating shaft.

Anti-static wood-board bed surfaces are fixed on the head unit active frame, the waist unit active frame, the thigh unit active frame and the calf unit active frame, sponges are disposed on the anti-static wood-board bed surfaces and the fixed bed surface.

Active connection stopper rods are installed on both sides of the bed frame and the calf unit active frame.

When the front electric device is activated, pushed by the front screw pushrod, the head unit active frame and the waist unit active frame bend upward.

When the rear electric device is activated, pushed by the rear screw pushrod, the hinge between the thigh unit active frame and calf unit active frame forms an upward protrusion, which allows the bed surfaces to form a five-bend shape.

A wireless remote control is employed by the front electric device and the rear electric device.

This folding five-bend electric bed, which is equipped with electric devices, is made of high-quality square steel tubes or carbon fiber material and mainly comprises the bed frames, bed body, bed surfaces and electric devices. The bed frames are composed by a number of rectangular frames, which are connected to each other by a plurality of active rotating shafts therebetween (which may be used for folding); Bed legs are provided under the four corners and both sides of the center of the whole bed frame, respectively; A plurality of transverse and perpendicular bars and pivot points are provided inside the bed frames for reinforcing and carrying the bed body; The bed body is composed of a plurality of unit active frames of varying sizes. Both sides of the unit active frames are connected by movable rotating shafts therebetween. A certain space is left between the bed body installed inside the bed frames and the bed frame, which facilitates raising and lowering both of the forward and rearward ends. The upper edges of the bed body and the bed frame define a planar surface; The bed surfaces consist of a plurality anti-static wood boards and sponges, which are fixed separately on the unit active frames and function primarily to carry the mattress and the human body; The electric devices consist of two miniature wireless remote control electric devices that are installed at the bottom centers of the bed frames, the bases of which are fixed on the bed frames, and the screw pushrods thereof are connected to the bed body through shafts. By remote control operation, the screw pushrods may be moved forward and backward freely so as to drive the unit active frames of the bed body to be raised up and lowered down, and the bed surfaces forms a fixed curvilinear shaped plate.

The beneficial effects of the present invention are:

1. The design is scientific and the structure is unique. On the basis of summing up advanced design concepts of similar products at home and abroad, the present invention which has a unique structural principle is a successful design through practices and scientific argumentations. Because the entire bed body is provided with a number of articulation points, it may achieve a multi-directional and multi-level folding and may be folded either once or several times. And the different requirements of transport, storage and use may be fully satisfied.

2. It is fully functional and multi-use. The present invention can achieve the aim to be multi-use according to the requirements of different groups of people. Since a number of articulation connecting points (active rotating shafts) are ergonomically set on the bed, through the remote control operation, driven by the motors, the bed body may be raise and lowered. The bed can be used as a flat bed, also the angles at the front and rear ends of the bed can be adjusted for personalization options. Either the height and angle at the front end of the bed body only may be adjusted, so that the human head, back and legs form three natural curves, or the rear end of the bed can be adjusted and raised at the same time, so that the human head, back, buttocks, thighs and calves form five curves to accommodate the natural bending angle of the human body, such that the body parts are in the best state of relaxation, thereby the most comfortable rest may be obtained, and the needs of all types of people groups can be fully met. Once input is needed, and the users may benefit from it all their lives.

3. The technology is innovative and leading domestic. According to the domestic market research and information novelty research, the present invention is a technology leader in bed products, and can be widely used in hotels, hospitals, homes and other fields, with a great market potential and promotional value.

### BRIEF DESCRIPTION OF THE DRAWINGS

FIG. 1 is a schematic representation of the present invention in using state.

FIG. 2 is a schematic plan view of the present invention.

FIG. 3 is a bottom view of FIG. 2.

FIG. 4 is a perspective schematic view of FIG. 1.

Reference numerals: 1. bed frames; 2. transverse bars; 3. active rotating shafts; 4. bed body; 5. head unit active frame; 51. waist unit active frame; 52. thigh unit active frame; 53. calf unit active frame; 6. active rotating shaft; 7. active rotating shaft; 8. buttock fixed bed surface; 9. bed legs; 10. front electric device; 101. rear electric device; 11. front screw pushrod; 111. rear screw pushrod; 12. front rotating shaft; 121. rear rotating shaft; 13. front supporting seat; 131. rear supporting seat.

### DETAILED DESCRIPTION OF THE INVENTION

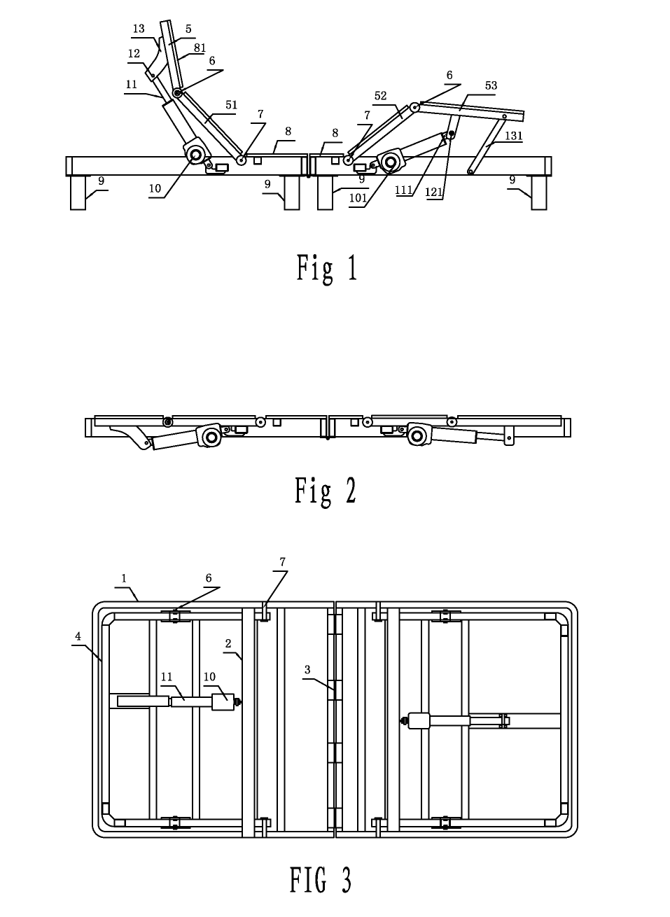

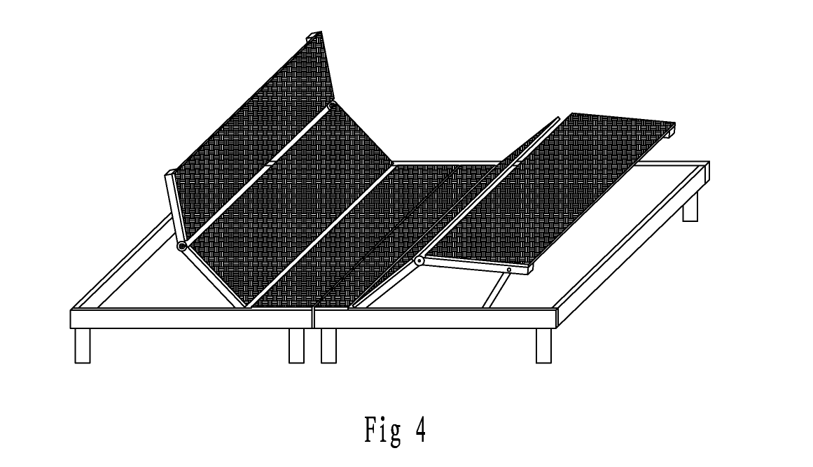

Referring to FIGS. 1, 2, 3 and 4, a folding five-bend electric bed comprises two bed frames 1 folded over each other, transverse bars 2 are provided on the bed frames, the two bed frames are articulated by active rotating shafts 3 therebetween, and bed legs 9 are provided at the bottom of the four corners and both sides of the center of the bed frame;

A bed body 4 composed of a head unit active frame 5, a waist unit active frame 51, a thigh unit active frame 52, a calf unit active frame 53 and a buttock fixed bed surface 8 is installed inside the bed frames 1; The head unit active frame 5 and the waist unit active frame 51 are hinged to each other by an active rotating shaft 6; The waist unit active frame 52 and the active rotating shaft 7 on the bed frame 1 at the buttock fixed bed surface 8 are hinged to each other; The thigh unit active frame 52 and the calf unit active frame 53 are hinged to each other by an active rotating shaft 6; The thigh unit active frame 52 and the active rotating shaft 7 on the bed frame 1 at the buttock fixed bed surface 8 are hinged to each other;

A front electric device 10 having a front screw pushrod 11 thereon and a rear electric device 101 having a rear screw pushrod 111 thereon are installed at the centers bellow the two bed frames 1, respectively, the front end of the front screw pushrod 11 is connected to a front supporting seat 13 at the bottom of the head unit active frame 5 by a front rotating shaft 12, and the front end of the rear screw pushrod 111 is connected to a rear supporting seat 131 at the bottom of the calf unit active frame 53 by a rear rotating shaft 121.

Anti-static wood-board bed surfaces 81 are fixed on the head unit active frame 5, the waist unit active frame 51, the thigh unit active frame 52 and the calf unit active frame 53, sponges are disposed on the anti-static wood-board bed surfaces 81 and the fixed bed surface 8.

Active connection stopper rods 14 are installed on both sides of the bed frame 1 and the calf unit active frame 53.

When the front electric device 10 is activated, pushed by the front screw pushrod 11, the head unit active frame 5 and the waist unit active frame 51 bend upward.

When the rear electric device 101 is activated, pushed by the rear screw pushrod 111, the hinge between the thigh unit active frame 52 and calf unit active frame 53 forms an upward protrusion, which allows the bed surfaces 81 and 8 to form a five-bend shape.

A wireless remote control is employed by the front electric device 10 and the rear electric device 101.

All the bed legs 9 must be removed first to fold the bed frames 1, which are then folded up for easy transport, storage and use.

In use, when the function keys 1 (not shown in the figures) on the remote controller are pressed down, the front electric device 10 mounted on one end of the bottom center of the bed frame starts work, the screw pushrod 11 stretch upward and forward, then the unit active frame 5 of the bed body connected thereto pushed by the linking rotating shaft 12 begins to be lifted upward, which causes the other unit active frame linked thereto to follow and be lifted. When the screw pushrod 11 stretch to a certain length (which can be adjusted freely), release the keys, and the electric apparatus 10 will stop operating, with the bed body forming a certain angle. Then the front (head) of the bed surface 8 may present a three-bend state; When function keys 2 of the remote controller are pressed, similarly, the rear electric device 101 mounted on the other end of the bottom center of the bed frame starts work, the rear part of the bed body rises, then the whole bed surface 8 forms a complete natural five-bend state (see FIG. 1). When the function keys 3 and 4 of the remote controller are pressed down, both of the front and rear electric devices start work, the screw pushrods retract and recover, and the bed surfaces present a flat state (see FIG. 2).

The preferred embodiments of the present invention have been described in detail above with reference to accompanying drawings, but the present invention is not limited to the above embodiments, and various changes may be made without departing from the concepts of the present invention.

1. A folding five-bend electric bed, wherein it comprises two bed frames (1) folded over each other, transverse bars (2) are provided on the bed frames, the two bed frames are articulated by active rotating shafts (3) therebetween, and bed legs (9) are provided at the bottom of the four corners and both sides of the center of the bed frame;
A bed body (4) composed of a head unit active frame (5), a waist unit active frame (51), a thigh unit active frame (52), a calf unit active frame (53) and a buttock fixed bed surface (8) is installed inside the bed frames (1); The head unit active frame (5) and the waist unit active frame (51) are hinged to each other by an active rotating shaft (6); The waist unit active frame (52) and the active rotating shaft (7) on the bed frame (1) at the buttock fixed bed surface (8) are hinged to each other; The thigh unit active frame (52) and the calf unit active frame (53) are hinged to each other by an active rotating shaft (6); The thigh unit active frame (52) and the active rotating shaft (7) on the bed frame (1) at the buttock fixed bed surface (8) are hinged to each other;
A front electric device (10) having a front screw pushrod (11) thereon and a rear electric device (101) having a rear screw pushrod (111) thereon are installed at the centers bellow the two bed frames (1), respectively, the front end of the front screw pushrod (11) is connected to a front supporting seat (13) at the bottom of the head unit active frame (5) by a front rotating shaft (12), and the front end of the rear screw pushrod (111) is connected to a rear supporting seat (131) at the bottom of the calf unit active frame (53) by a rear rotating shaft (121).

2. The folding five-bend electric bed according to claim 1, wherein anti-static wood-board bed surfaces (81) are fixed on the head unit active frame (5), the waist unit active frame (51), the thigh unit active frame (52) and the calf unit active frame (53), sponges are disposed on the anti-static wood-board bed surfaces (81) and the fixed bed surface (8).

3. The folding five-bend electric bed according to claim 1, wherein active connection stopper rods (14) are installed on both sides of the bed frame (1) and the calf unit active frame (53).

4. The folding five-bend electric bed according to claim 3, wherein when the front electric device (10) is activated, pushed by the front screw pushrod (11), the head unit active frame (5) and the waist unit active frame (51) bend upward.

5. The folding five-bend electric bed according to claim 4, wherein when the rear electric device (101) is activated, pushed by the rear screw pushrod (111), the hinge between the thigh unit active frame (52) and calf unit active frame (53) forms an upward protrusion, which allows the bed surfaces (81, 8) to form a five-bend shape.

6. The folding five-bend electric bed according to claim 5, wherein a wireless remote control is employed by the front electric device (10) and the rear electric device (101).

7. The folding five-bend electric bed according to claim 2, wherein active connection stopper rods (14) are installed on both sides of the bed frame (1) and the calf unit active frame (53).
